(19) United States
(12) Patent Application Publication
(10) Pub. No.: US 2026/0310993 A1
(43) Pub. Date: Oct. 8, 2026

(54) AI-DRIVEN PERSONAL ASSISTANT SYSTEM AND METHOD FOR AUGMENTING USER INTELLIGENCE AND COGNITION

(71) Applicant: Thomas DANIELE, Clinton Corners, NY (US)

(72) Inventor: Thomas DANIELE, Clinton Corners, NY (US)

(21) Appl. No.: 19/631,631

(22) Filed: Mar. 27, 2026

Related U.S. Application Data
(60) Provisional application No. 63/785,295, filed on Apr. 8, 2025.

(51) Int. Cl. G06N 5/022; G06F 3/01

(52) U.S. Cl. CPC G06N 5/022; G06F 3/015

(57) ABSTRACT

A brain-inspired computing system and methods of its use are provided. More specifically, the system is an AI-driven personal assistant computing system which comprises several components and functionalities, such as, without limitation: persistent multi-modal information collection and memory engine for continuously capturing and storing user data in a long-term personal knowledge database secured by user-controlled encryption; contextual association and awareness to automatically retrieve and present relevant information to a user upon detecting a context cue or user query; proactive automation to monitor the user's environment and behavior patterns; suggesting or executing tasks based on learned user routines; cross-domain analytics to correlate data from the user's personal and professional domains and provide holistic insights; and privacy-centric architecture wherein personal data is stored in a decentralized manner under user-owned encryption keys; governing the assistant's actions based on user-defined privacy rules.

### CROSS-REFERENCE TO RELATED APPLICATIONS

The present application claims the benefit of U.S. Provisional Application No. 63/785,295, filed Apr. 8, 2025, the entire disclosure of which is incorporated by reference herein.

### FIELD OF THE INVENTION

The present disclosure relates to the field of artificial intelligence (AI) and digital assistants, including brain-inspired personal computing systems and methods for supplementing and enhancing human intelligence and function. More particularly, the present disclosure relates to an AI-driven personal assistant system, and methods for its use, which provide AI-driven augmentation of user intelligence and cognition.

### BACKGROUND

Modern individuals are inundated with information and tasks, often beyond the capacity of an individual human's memory, attention, and management. People frequently end their day mentally exhausted from juggling and prioritizing to-do lists, notifications, and fragmented information streams, leading to cognitive overload. A study by McKinsey Global Institute, The Social Economy: Unlocking Value and Productivity Through Social technologies, July 2012, by Chui, M., et al., reported that knowledge workers spend about 1.8 hours each day—roughly 20% of the workweek—searching for or re-creating information they have seen before. This inefficiency highlights a gap between the abundance of digital information and the human ability to manage and recall it.

Artificial intelligence (AI) assistants (such as smartphone voice assistants and chatbot systems) have emerged with the promise of alleviating information overload and improving productivity. However, current mainstream AI assistants have several significant limitations including, but not limited to, the following. First, they have no long-term memory or continuity—most assistants operate without persistent memory and do not retain context across sessions. For example, a conventional voice assistant does not remember what a user told it yesterday, and even advanced conversational models reset context with each new session. There is no evolving personal knowledge base that grows with the user.

A second limitation of today's current mainstream AI assistants is that they offer only limited personalization and context awareness; they lack deep, ongoing awareness of the user's situation and surroundings. They might know basic user profile details or a few preferences, but they do not continuously observe contextual factors (e.g. location, activity, schedule, physiological state) in real time. Consequently, their assistance remains generic and short-sighted—for instance, if a meeting runs late or the user appears stressed, a typical assistant will not notice or proactively adjust the user's schedule.

Finally, a third limitation of current AI helpers is that they are largely reactive rather than proactive. They act only when explicitly invoked by the user or when a preset alarm triggers, lacking true autonomous initiative to optimize workflows. For example, if a user spends every Monday morning sorting emails, present-day assistants will not autonomously begin organizing or summarizing those emails; they simply wait for user commands.

Existing AI-driven assistants have not fully addressed the foregoing cognitive challenges. In short, they typically function as passive, stateless tools rather than collaborative intelligent partners, due to their absence of persistent memory, comprehensive context integration, and proactive behavior. While some recent developments have begun to address portions of the foregoing issues, no existing system combines all of the needed capabilities into a single integrated personal assistant system.

For example, U.S. Patent Application Publication No. 2023/0245651 A1 to Polypie Inc., describes a user-centered, contextually aware AI assistant with environmental sensors and contextual learning, but it lacks a persistent personal memory vault under user control. That system focuses on real-time context and immediate task assistance, without teaching an evolving autobiographical memory that the user can manage. It also does not disclose the kind of decentralized, user-governed privacy architecture of the present invention.

In another example, U.S. Patent Application Publication No. 2024/0354641 A1 to Snap Inc., discloses using multimodal memory embeddings to recommend content and augment social interactions, but its scope is narrow. Rather, U.S. 2024/0354641 is geared toward media and social context recommendations, and does not provide general long-term personal memory or proactive task execution across domains.

Existing AI systems lack persistent multimodal memory and proactive automation in a unified, privacy-centric framework. Accordingly, there is a clear need for an improved personal intelligence assistant that integrates long-term memory, context awareness, proactive assistance, cross-domain intelligence, and user-directed privacy governance into a single system. The invention disclosed and contemplated herein addresses this need by providing an AI-driven personal assistant system with multiple integrated components and functionalities which are arranged to provide and operate a secure, private, decentralized, and continuously learning and updating personal assistant system.

### SUMMARY OF THE INVENTION

In an exemplary embodiment, a method for artificial intelligence (AI)-driven augmentation of user cognition, involving interaction with a user and comprising the steps of: processing user-related data with associated context information and providing a personal knowledge database containing memories comprising the user-related data and associated context information, wherein the memories are searchable and retrievable as long-term memories; performing data encryption, local, decentralized, or local and decentralized, storage of information and data, and enforcement of user privacy settings; evaluating context information, making decisions, carrying out user-task automation, and providing suggestions to the user; and performing cross-domain data analysis, and generating personalized insights, recommendations, or both.

The step of processing user-related data with associated context information and providing a personal knowledge database, may each comprise one or more actions selected from capturing, analyzing, and storing, the user-related data with the associated context information.

The method may further comprise sensing and capturing context information with associated user-related data, using one or more devices, and presenting the context information with its associated user-related data to the user through one or more interfaces. For example, sensing and capturing context information may be performed using one or more devices including cameras, microphones, and location sensors, etc.

The method may further comprise receiving input which includes neural signals from the user's brain through one or more brain-computer interface (BCI) devices and neural sensors capable of sensing and transmitting neural signals, and using the input which includes neural signals when performing at a least portion of one or more other steps of the method.

The method may further comprise the steps of: performing continuous audio recognition, detection, and capture; recording and storing captured audio in local memory, remote offline memory, or both, which is capable of receipt and at least temporarily storing the captured audio; automatically transmitting audio from an audio receipt and capture device to either local offline memory capacity, remote offline memory capacity, or both; and transmitting, uploading, or both transmitting and uploading stored audio from either of the local or remote offline memory capacities to one or more remote or decentralized storage networks, upon receipt of instructions and authorization from the user. The step of performing continuous audio recognition, detection, and capture may be performed at least in part using an audio receipt and capture device (e.g., a microphone), which is carried or not on a wearable device configured to be worn by the user.

In another exemplary embodiment, a personal assistant system is provided for performing and providing artificial intelligence (AI)-driven augmentation of user cognition, and which is accessed and operated by a user, the system comprising: a memory engine which is configured and programmed for processing user-related data with associated context information which provides a personal knowledge base (database) containing memories with context which is searchable and retrievable as long-term memories; a privacy/data management subsystem which is configured and programmed for performing data encryption, local and decentralized information and data storage, and enforcement of user privacy settings; a context recognition and user interface subsystem which is configured and programmed for sensing and capturing context information using one or more devices, and also for presenting the context information with its user-related data to the user; an automation and decision engine which is configured and programmed for evaluating context, making decisions, and for carrying out user-task automation and providing suggestions; and an analytics and insight module which is configured and programmed for performing cross-domain data analysis and generation of personalized insights, recommendations, or both.

The processing by the memory engine may comprise one or more actions selected from capturing, analyzing, and storing, the user-related data with the associated context information.

The sensing and capturing context information by the context recognition and user interface subsystem is performed using one or more devices including cameras, microphones, and location sensors, etc.

The presenting the context information with its user-related data to the user by the context recognition and user interface subsystem is performed through one or more interfaces selected from: augmented reality displays, visual output, audio output, and other notification media.

The system may further comprise a governance and control module which is configured and programmed for enforcing user-defined rules, managing permissions, and ensuring transparent and ethical AI operations. One or more of the user-defined rules, the permissions, and the transparent and ethical AI operations which are managed by the governance and control module may be: defined by the user, set based on one or more external sources including legal requirements and limitations, privacy standards, and ethical standards and considerations, or both defined by the user and set based on one or more external sources.

The system may further comprise a neural interface module which is configured and programmed for receiving input from brain-computer interface (BCI) devices and other neural sensors which transmit or otherwise provide neural signals to one or more modules of the system which uses the neural signals to analyze, determine and influence for the system's operation and behavior.

In an embodiment, the system may further comprise a bridging device which includes a multifunctional standalone component comprising: an audio receipt and capture device (e.g., a microphone) capable of continuous audio recognition, detection, and capture; memory capable of offline recording and storage of captured audio, including local and offline memory capacity for receipt and storage of captured audio, remote memory capacity capable of receiving and at least temporarily storing captured audio, or both local and remote memory capacity; and one or more transmitters, each of which uses RFID, Bluetooth, IR, and other effective transmission formats and technologies which are same or different from those of others of the one or more transmitters, wherein a first one of the one or more transmitters is capable of automatically transmitting audio from the audio receipt and capture device to either local offline memory capacity, remote offline memory capacity, or both, wherein the first one of the one or more transmitters, or at least a second one of the one or more transmitters, is further capable, upon receipt of instructions and authorization from the user, of further transmitting, uploading, or both transmitting and uploading stored audio from either of the local or remote offline memory capacities to one or more remote or decentralized storage networks.

The bridging device may further comprise software instructions, applications, specialized programmed hardware computing devices, or a combination thereof, installed thereon and capable of operating one or more personal user devices and utilizing secure cloud and edge resources, which provides enhanced and expanded functionality of the of the bridging device and its subparts.

A method for artificial intelligence (AI)-driven augmentation of user cognition, the method comprising: remembering information indefinitely, providing contextually relevant assistance at contextually relevant moments, and acting autonomously on a user's behalf under intelligent supervision, and concurrently maintaining user control of data and decisions. Remembering information may comprise at least capturing, storing, and recalling information. The method may further comprise functionalities which include: persistent memory, contextual awareness, proactive automation, cross-domain intelligence, and privacy governance, and may further comprise extending human memory and executive function, as well as assist with overcoming information overload by the user.

### BRIEF DESCRIPTION OF THE FIGURES

The present invention will be further explained with reference to the attached drawings, wherein the same reference labels are used across figures to denote corresponding elements of the system in different contexts.

FIG. 1 is a is a block diagram providing an overview of an exemplary embodiment of the AI-driven personal assistant system and its architecture, and showing several components of the system, their functions and multi-modal interactions with user devices, data sources, and each other;

FIG. 2 is a flowchart showing an exemplary method, implemented by one or more of the components of the AI-driven personal assistant system, for performing multi-modal data capture and memory storage in the system, from initial sensing or detection of such data through processing, privacy filtering, storage, and indexing of the information;

FIG. 3 is a flowchart showing an exemplary method, implemented by one or more of the components of the AI-driven personal assistant system, for performing contextual memory recall process, wherein the system retrieves and presents stored information to a user in response to a user query or a recognized context cue or trigger; and

FIG. 4 is a flowchart showing an exemplary method, implemented by one or more of the components of the AI-driven personal assistant system, for performing proactive suggestion and automation, wherein the system monitors a user's context, identifies a trigger condition for assistance, formulates a suggested action or an automated (pre-approved or programmed) action, and executes such action, automatically or with user approval when required.

FIG. 5 is a flowchart diagram of a federated learning and model update process which may be performed according to some embodiments of the AI-driven personal assistant system for continued training, updating, and improvement of the system based on collective learning (e.g. adapting to new slang or scenarios observed in others' data) without exposing individual data and maintaining personal privacy;

FIG. 6 is a flowchart of a brain-computer interface (BCI) integration process which may be performed according to some embodiments of the AI-driven personal assistant system and during which neural inputs are provided to and processed by the AI-driven personal assistant system to determine whether the neural signal corresponds to a deliberate user command/intent which may be converted to an action, or is simply contextual data (such as an emotional state) to be stored;

FIG. 7 is a flowchart showing the privacy and data governance processes performed by the privacy/data management subsystem which enables the AI-driven personal assistant system to receive, analyze and, store and otherwise manage user data, including execution of date deletion requests from the user, with prioritization of protecting user privacy;

FIG. 8 is a process flow diagram which provides a summary of the path of user data and its receipt, management, storage, and use by the AI-driven personal assistant system, from input to output, to explain how the system senses, decides, learns, and acts based on the user data and information it receives;

FIG. 9 is a schematic diagram showing, at a high level, six general stages of operation (900) performed by the AI-driven personal assistant system to clarify and emphasize the system's design and operation as an ever-learning personal assistant system that proactively adapts, through iterative operation, to better serve the user over time;

FIG. 10 is a flowchart showing how the AI-driven personal assistant system is capable of collaborative use of multiple user devices to share tasks and data efficiently; and

FIG. 11 is a diagram which shows the arrangement of setting options provided on the system's control panel interface for enabling the user to control the AI-driven personal assistant system's behavior in three key areas: privacy permissions, automation approvals, and data retention.

### DETAILED DESCRIPTION

Detailed explanations and embodiments of the AI-driven personal assistant system and method disclosed and contemplated herein are described below. It should be understood, however, that the embodiments of the system described herein are merely illustrative, and not intended to be limiting. Rather, the AI-driven personal assistant system may be embodied and practiced in various alternative and overlapping versions. In addition, any examples provided in connection with the various embodiments of the AI-driven personal assistant system and method described and contemplated herein are intended to be illustrative, and not restrictive.

Finally, unless otherwise explicitly stated hereinbelow, pronouns in the singular, such as “a” and “the,” are not intended to be limited to meaning that only one of the features, compositions, or method steps being described is present or performed. Rather, use of such pronouns with features, compositions, or method steps, being described means that “at least one” or “one or more” such feature, composition, or method step is present or performed.

Generally, the AI-driven personal assistant system is an innovative AI-integrated wearable personal memory and cognitive system which includes multimodal information sourcing such as, without limitation, visual, verbal, digital, and biometric data inputs, for use in providing enhanced recall, decision-making, and cognitive augmentation to a user in a decentralized, personal, secure, and continuously learning AI-driven environment.

More specifically, the AI-driven personal assistant system is a combination of several components, each of which provides one or more AI functionalities which are organized and integrated into a single, user-centric assistant system. The system augments the user's cognition by remembering (e.g., one or more of capturing, storing, and recalling) information indefinitely, providing contextually relevant assistance (information, suggested and/or automated actions) at the right moments, and acting autonomously on the user's behalf under intelligent supervision—all while keeping the user in control of data and decisions. This combination of functionalities—i.e., persistent memory, contextual awareness, proactive automation, cross-domain intelligence, and privacy governance—provides one exemplary embodiment of the AI-driven personal assistant system which provides new and advantageous features and benefits as compared to existing personal assistants. By integrating these elements, the presently described and contemplated AI-driven personal assistant system and method provides a powerful and practical tool which extends human memory and executive function, thereby helping users overcome information overload and manage their lives more efficiently and securely.

The AI-driven personal assistant system comprises several components, each of which performs or enables the performance of one or more functions and methods, and each of which communicates and cooperates with one or more of other components to provide the system with one or more features and functionalities.

In one exemplary embodiment, for example, the system comprises at least the following components and functionalities:
a memory engine which is configured (programmed) for processing (e.g., capturing, analyzing, and storing) user-related data with associated context information which provides a personal knowledge base (database) containing memories with context which is searchable and retrievable as long-term memories;
a privacy/data management subsystem which is configured (programmed) for performing data encryption, information/data storage (local and/or decentralized), and enforcement of user privacy settings;
a context recognition and user interface subsystem which is configured (programmed) for sensing and capturing context information using, for example, without limitation, using cameras, microphones, location sensors, etc., and also for presenting such context information with its user-related data to the user (such as, without limitation, through interfaces such as augmented reality displays, visual output, audio output, or other notification media);
an automation and decision engine which is configured (programmed) for evaluating context, making decisions, and carrying out user-task automation or providing suggestions (i.e., suggested actions);
an analytics and insight module which is configured (programmed) for cross-domain data analysis and generation of personalized insights or recommendations; and
a governance and control module which is configured (programmed) for enforcing user-defined rules, managing permissions, and ensuring transparent and ethical AI operations.

The system may, optionally, further comprise a neural interface module which is configured (programmed) for receiving input from brain-computer interface (BCI) devices or other neural sensors which, in turn, enables neural signals to influence the system's operation and behavior.

The system may, optionally, further comprise a bridging device which is a multifunctional standalone component, such as but not limited to a wearable device, which includes at least the following subparts and is capable of at least the following functionalities:
an audio receipt and capture device, such as without limitation a microphone, which is capable of continuous audio recognition, detection, and capture;
memory capable of offline recording (storage) of captured audio, such as without limitation, local (offline) memory capacity for receipt and storage of captured audio, or remote memory capacity capable of receiving and at least temporarily storing captured audio,
one or more transmitters, each of which uses, for example without limitation, RFID, Bluetooth, IR, and other effective transmission formats and technologies, which may the same or different from other transmitters, and wherein a first one of the one or more transmitters is capable of automatically transmitting audio from the audio receipt and capture device to either local offline memory capacity or remote offline memory capacity, wherein the first one of the one or more transmitters, or at least a second one of the one or more transmitters, is further capable, upon receipt of instructions and authorization from the user, of further transmitting/uploading stored audio from either of the aforesaid local or remote offline memory capacities to one or more remote or decentralized storage networks such as, without limitation, a cloud server, or a blockchain-based storage node.

Enhanced functionality of the bridging device and its subparts may be achieved by having software instructions, applications, specialized programmed hardware computing devices, or a combination thereof, installed and operating one or more personal user devices, as well as on secure cloud or edge resources. For example, the memory engine may run partially on a user device to capture sensor data, while utilizing cloud-based or distributed storage nodes to back up encrypted data.

Basically, aforesaid components, with or without one or more of the aforesaid optional components, cooperate and function in the AI-driven personal assistant system as follows. Initially, various input sources and sensors, which are often by not necessarily always separate and independent from the system, and include without limitation one or more of: cameras, microphones, keypads, biometric sensors, a user's smartphone applications, wearable devices, and the like, sense, receive and collect data which is first received by the privacy/data management subsystem of the AI-driven personal assistant system.

The privacy/data management subsystem filters data from input sources and sensors, based on user selected rules and settings, to identify and then provide permitted data to the memory engine for processing, while ensuring that disallowed data is not stored. For example, when disallowed data, which has been identified by a user as data which is not to be saved, transmitted, stored, or otherwise used by the system, is received by the privacy/data management subsystem, it may simply be deleted without any record thereof. Alternatively, privacy/data management subsystem may be programmed for disallowed data to trigger addition of an entry to a log which simply states that data or other information was received, but ignored due to a privacy rule, without retaining the actual content of the data or information.

The memory engine organizes permitted data received from the privacy/data management subsystem, into a structured personal knowledge base (database) which comprises a secure data store which is managed by the memory engine and privacy/data management subsystem components.

The context recognition and user interface subsystem continuously monitors the user's environment and activities and provides context signals to one or more other components of the system. When a situation calls for assistance, the automation/decision engine uses information from the personal knowledge base and the current context to either perform an automated action or generate a suggestion (i.e., a suggested action) for the user. The analytics and insight module provides deeper analysis by correlating long-term data and user-specific metrics, informing the decision engine and also offering periodic insights to the user. The governance and control module oversees all of the foregoing operations to ensure they comply with the user's rules and preferences. The governance and control module may also record the system's actions in a log for transparency and future reference by the user.

If a BCI device or other neural sensor is present, the neural interface module receives and interprets neural inputs from such a device or sensor. Neural inputs include, for example without limitation, detecting a thought pattern as a command, or using a measured cognitive or emotional state as contextual data. The neural interface module feeds such commands and contextual data to the context and decision-making layers such as, without limitation, the context recognition and user interface subsystem and the automation and decision engine, which expands the input modalities of the system. Through user interfaces (including but not limited to AR glasses, a smartphone screen, voice output, etc.), the system communicates back to the user by presenting recalled information, prompting for approvals, displaying insights, or confirming actions.

### The Data Capture and Storage Workflow Method and the Personal Knowledge Base

The AI-driven personal assistant system builds and maintains a comprehensive, privacy-protected, personal knowledge base comprising information and memories specific to the user and the user's experiences and environment by performing a data capture and storage workflow method, which is continuously executed by system in the background (unless paused by the user). The data capture and storage workflow method generally comprises capturing incoming permitted data from input sources associated with the user and the user's environment, processing that data, and storing it as an event with associated context in a long-term memory personal knowledge base. The capture and storage workflow method continuously updates and organizes the events and other information in the personal knowledge base to facilitate rapid and easy recall of data and events. An exemplary embodiment of the capture and storage workflow comprises the following steps: capturing a sensor/event; performing a privacy filter check; processing and analyzing data; attaching or associating context with the sensor/event; event formation/integration; categorizing and prioritizing the sensor/event; selecting secure storage of the sensor/event; updating memory index; optionally performing real-time post-processing analysis and issuing alerts.

The capture and storage workflow method includes key decision points such as the privacy permission checks and event segmentation logic and ensures that only authorized data and information are preserved, that each memory/event is contextually enriched, and that it is stored in a manner that both facilitates future recall and safeguards the user's privacy and security. Additional details and explanation will now be provided for each step of the capture and storage workflow method.

Sensor/Event Capture: The system collects raw data from various sensors and input sources associated with the user. This may include, for example, audio captured by a microphone (e.g., conversations the user is involved in), images or video from a camera (e.g., the user's smart glasses capturing what the user sees), location data from a GPS module, text from the user's digital communications (emails, messages), or biometric readings from wearables (heart rate, EEG signals, etc.). Each piece of incoming data is tagged with basic metadata such as a timestamp and source type. For instance, an audio snippet might be tagged as “audio_input, time 10:32 AM, source: smartphone microphone.”

Privacy Filter Check: Before any raw data is committed to memory, the system consults the user's privacy preferences which are enforced by the privacy/data management subsystem. The system determines whether the given type of data, in the current context, is permitted data which is to be recorded. For example, the user may have a rule that disallows recording audio when at home, or that prevents storing location data during certain hours. If a piece of data fails the privacy check (i.e., it is not allowed by the user's rules), that data is immediately discarded or sanitized (not stored in memory). Optionally, the system can log that an input was ignored due to a privacy setting for transparency, without retaining the content. If the data passes the privacy filter, the capture process continues for that data.

Data Processing and Analysis: The system processes the raw data to extract structured information and meaningful features. Depending on the modality, this may involve different AI models or algorithms. For example, if the input is audio, the system uses speech-to-text processing to obtain a transcript of spoken words and may apply natural language processing (NLP) to identify entities, topics, or sentiment. If the input is an image or video frame, computer vision algorithms may be applied (for example, face recognition to identify persons, object detection to catalog objects/scenes, or OCR to read any text in the image). For biometric or numerical data, the system interprets those signals (such as, for example, by converting heart rate data into a stress level indicator). The outcome of this step is that raw data is transformed into a structured event or record. For example, an audio recording from a meeting might become a text transcript with identified speakers and topics; an image might yield a list of recognized faces and objects, etc. Converting raw data into structured events and records facilitates later search and recall of the information.

Context Attachment: The system augments the structured data with additional contextual metadata to situate it in the user's personal timeline and environment. In essence, the system ensures comprehensive tagging of the “who, what, when, where, and why” for each captured item. For instance, the exact timestamp is standardized and recorded (if not already). The system associates the data with context such as the user's current location (if available), the active activity or application, nearby people (if face recognition identified someone), and any other relevant context (e.g., whether this occurred during a scheduled meeting on the user's calendar). This metadata enriches the memory record. As an example, if the user took a photo at a conference, the system might tag it with the event name, location, and people in the photo. By attaching rich context, each memory becomes easier to retrieve later by contextual cues.

Event Formation/Integration: The AI-driven personal assistant system groups related pieces of data into higher-level “events” in an episodic memory structure. In this context, an “event” is a collection of data points which all pertain to a particular incident or time period. The system checks if the new data corresponds to an ongoing event or if it should start a new event record. For example, if a meeting event is already in progress (based on timing and participants), additional notes or images captured during that meeting will be added to the existing “event” entry or record. If the incoming data is unrelated to any current event (e.g., the user has just started a new activity or conversation), the system will create a new “event” entry/record for that segment of time. By organizing memories into such events, the system mimics how human episodic memory works—grouping memories by context and episode—which later aids in contextual memory recall from the user's personal knowledge base. An event entry/record may contain multiple types of data; for instance, an event labeled “Project X Meeting at 10:30 AM” could include that meeting's audio transcript, pictures of a whiteboard, and a copy of a shared file, all contained in one event entry/record.

Categorization & Prioritization: The AI-driven personal assistant system analyzes the content and context of the newly formed or updated event to categorize it and assess its significance. Using the information available (keywords from text, identities of people involved, the user's calendar, etc.), the system may assign one or more category labels to the event (for example, without limitation, “Work/Project X,” “Personal/Family,” “Health,” etc.). Additionally, the system computes a priority or importance score for the event. This can depend on various factors: an event involving a critical work project or a notable personal occasion might be marked as high importance; an event where the user exhibited stress or that includes a promised follow-up task could also be flagged as high priority. Conversely, routine or trivial events might be tagged as low priority. The user's own input can influence this categorization (the user might manually flag certain moments as important). The assigned category and priority become part of the event's metadata and will influence how the system treats the event in the future (for instance, high-priority events might be recalled or acted upon more readily).

Secure Storage Selection: Once the event data is prepared, the system decides where and how to store the data, in accordance with its privacy-preserving architecture. The privacy/data management subsystem includes a storage manager which selects storage targets for the data of an event. Typically, the storage manager stores at least two copies of the data for redundancy: one copy on a local device or personal server controlled by the user, and another copy on a remote or decentralized storage network such as, without limitation, a cloud server, or a blockchain-based storage node. The choice of what type of decentralized storage network is used may depend on the sensitivity and size of the data. Highly sensitive data might, for example, be kept only on devices under the user's direct control or on encrypted nodes, whereas less sensitive data might also be backed up to a secure cloud server. In all cases, the data remains encrypted and inaccessible to third parties without the user's keys.

Memory Index Update: The AI-driven personal assistant system includes a memory index and, after (or concurrently with) storing the event, the system updates its memory index to include references to the new information. The memory index is a searchable index or database which enables the system to later retrieve memories relevant to a query or context. Updating the memory index may include adding keywords from a transcript into a search index, updating chronological indices by date/time, and indexing recognized entities (such as faces or names) so that those become queryable keys. Essentially, this step makes the new event “findable” for future recall operations by recording its salient features in the memory index.

Optional Post-Processing and Alerts: After the primary storage and indexing are accomplished, the system may perform additional analysis on the event data to derive immediate, or real time, value. For example, an analysis engine may retrieve and review the event and trigger follow-up actions or alerts, if certain preselected conditions or rules are detected or satisfied, respectively. For instance, if the system detects, in the event's transcript, that the user made a commitment (“I will email you the report”), it can create a task or reminder for the user to consider and follow up on. If biometric data in the event indicates a potential health issue (say an unusually high heart rate was recorded during the event), the system could generate an instant alert to the user. The system might also update user models or statistics-for example, incrementing a counter of how many times the user met a particular person if that person was present, or incorporating new vocabulary into its language model if new terms appeared. These post-processing actions allow the AI-driven personal assistant system to not only store data, but also to immediately learn from it and extract useful insights. This step is optional and configurable. The user can set what kinds of post-event analysis should occur.

After completion of the foregoing nine steps of the capture and storage workflow method, new permitted data has been securely stored and indexed in the personal knowledge base. The capture and storage workflow for that data item is complete, and the system returns to an idle monitoring state, awaiting the next incoming data or sensor event. The foregoing nine steps of the capture and storage workflow method repeat continuously for each new piece of permitted data received across all modalities. In effect, the system is constantly recording the user's digital and physical experiences (within the user's defined limits) and weaving them into an organized, secure personal memory that can later be searched or utilized by ongoing performance of the capture and storage workflow method. The continuous cycle described above provides the system with an “ever-evolving” intelligence to draw from. With each captured and stored event, the system's knowledge about the user grows richer.

### The Contextual Memory Recall Process—Retrieving Information from the Personal Knowledge Base

The AI-driven personal assistant system performs a contextual memory recall process for retrieving relevant information from memory (i.e., the personal knowledge base) in response to a trigger and presents that information to the user. This process can be initiated either by an explicit user query or by the system when it recognizes a context that calls for a memory recall (e.g., the system sees a familiar face or hears a keyword). An exemplary embodiment of the contextual memory recall process comprises the following steps which are performed when a recall trigger occurs: gathering context; formulating a memory query; searching and retrieving; ranking and selecting query results; generating a memory summary; and presenting information (output). Optionally, the step of presenting information may be followed by user follow-up and continuation. Additional details and explanation will now be provided for each step of the workflow of the contextual memory recall process.

Recall Trigger Occurs: The system may commence the contextual memory recall process when a recall is triggered by either a user action or an environmental/context cue. User action may, for example without limitation, include an explicit query from the user—for example, the user asks a question via voice or text, such as “What did I discuss with Alice last week?” Alternatively, an implicit trigger detected by the system's context recognition may occur. For example, without limitation, the user's cell phone or webcam camera may recognize a person in the user's view (e.g., identifies the face of “Alice”), or the user's GPS sensor notes the user arriving at a particular location that the system recognizes, e.g., from information or an event stored in the personal knowledge base of the system, is linked to certain past events. Such passive context triggers can prompt the system to retrieve information relevant to that person or place without the user having to ask. (The trigger could even be temporal, such as a scheduled meeting about to start.) For purposes of illustration, consider a scenario where the user is wearing AR glasses and encounters a colleague, Alice, whom the system recognizes; this visual recognition may serves as a recall trigger based on which the system performs the contextual memory recall process.

Context Gathering: Once a recall trigger is detected, the system gathers current context data to form a detailed query context. Current context data may, for example without limitation, include the identity of a recognized person (e.g., Alice's name or ID, determined via facial recognition or from a prior encounter record), the current date/time, the user's current location (for example, “Conference Room 5, Company HQ”), and any relevant activity information (the user's calendar might indicate this is a scheduled meeting with Alice). If the trigger was an explicit user question/query, the content of the user's query is also included as part of the context. Essentially, the system creates a snapshot of “now”—for instance, if the user is currently with Alice, at the office, in a meeting context, on a certain date/time, and perhaps asked about their last discussion. The system may use this collection of context data to inform and structure the memory search.

Memory Query Formulation: Using the collected context data, the system formulates a search query for the memory index. The query distills key parameters from the context into a form that can be matched against stored events. For example, continuing the foregoing exemplary scenario, the query might specify person=Alice and context=work meeting, possibly including time constraints (such as focusing on recent interactions). If the user explicitly asked a question (“What did we discuss?”), the system would also incorporate keywords from that question. In general, the system translates the situation and/or user query into search terms or into a vectorized query that aligns with how events are indexed in memory. In some embodiments, this translation could involve forming a structured database query (e.g., find events involving “Alice”) or generating an embedding representation of the query to match against stored event embeddings.

Search and Retrieval: The system searches the memory index (which is built and updated by the capture and storage workflow method described earlier) for stored events, information, or entries that match the formulated query criteria. Continuing the foregoing exemplary scenario, the query-based search might return an event from two weeks ago where Alice was present at a meeting with the user. If multiple events match (e.g., the user met Alice on several occasions), all such relevant results are retrieved. There is a decision point here: if the search finds no results that satisfy the query, the system may be programmed to handle that gracefully—for example, by informing the user that no relevant memory was found (or possibly by broadening the search to external sources if that is within the system's functionality, though by default the system focuses on the user's personal data and the personal knowledge base built and updated based thereon). If relevant query results are found, the contextual memory recall process continues to the result ranking step.

Result Ranking (Selection): If more than one memory item is retrieved, the system ranks the results by relevance to determine which information is most useful to provide to the user. The ranking is conducted based on consideration of factors such as, but not limited to, recency (often the most recent meeting with a person is most relevant to a current encounter), frequency (interactions that happen very often might be less critical to remind each time versus a rare interaction), semantic similarity to an explicit query, or any importance tags associated with the events. For example, if the user explicitly asked about “last week's discussion,” the system will prioritize events from last week over events which occurred before and after last week. In an implicit AR-trigger scenario where the user did not ask a specific question, recency may dominate (e.g., show the most recent meeting notes with Alice by default). The system might also consider the relevant or other importance of metadata associated with events or information identified in initial query results—for example, if one of the past meetings with Alice was flagged as high priority, that event might rank higher in the query results. Ultimately, the top result (or a small number of top results) is selected for output (i.e., presenting to the user for consideration). In many cases, a single event (for instance, the most recent relevant event) may be chosen for summarization.

Memory Summary Generation: The system generates a concise summary of the selected memory event to present to the user. This summary distills the key information from the retrieved event. For example, if the event was a meeting with Alice, the summary might include the date of the meeting, the main topics discussed, and any action items or decisions from that meeting. The summary generation may use natural language generation techniques to produce a human-readable synopsis (e.g., “You met Alice on March 10th; you discussed the new project timeline and she agreed to send you the data file. Action item: you promised to email a follow-up report.”). The goal is to present the user with the most relevant details at a glance, rather than overwhelming them with raw data.

Information Presentation (Output): The system presents the summary (or the relevant memory information) to the user via the appropriate user interface in real time. If the user is wearing an augmented reality display, the summary text (or visual cues) is overlaid in the user's view associated with the trigger (e.g., floating near Alice's face in the AR display). If the user is not using AR and instead asked the question via a voice interface or text chat, the system will either speak the summary or display it on the device's screen. The recall output is delivered promptly (ideally within a second or two of the trigger in the AR case) and privately, so that only the intended user perceives it. For instance, AR glasses would show the information only in the user's view, or a phone notification would be shown only on the user's device. The interface may also allow the user to request more detail if needed (for example, the user could ask a follow-up question or tap to expand the full notes of the past meeting). Once the information is presented, the immediate recall task is completed.

Optional User Follow-up and Continuation: Although the main goal of the contextual memory recall process is achieved at the previous information presentation step, the system may continue to monitor whether the user needs or requests further assistance. For example, if the user proceeds to have a conversation with Alice after seeing the recalled information, the system may quietly log this new interaction (essentially initiating the capture and storage workflow method applied to the current meeting with Alice, as a new event in memory). If the user asks a follow-up question like “When is our project deadline?”, the system can retrieve that information from memory or other data sources and present it similarly. In some embodiments, the system might also gauge the usefulness of the recall-for instance, whether the user seemed to use the information or if they explicitly acknowledged it- and use that information as feedback for future recalls. This user follow-up and continuation step is intended to facilitate continuity of user interaction rather than a suggesting or performing a distinct new action. After delivering the recall information to the user, the system remains available for any further queries, or it may seamlessly transition into capturing the ongoing interaction as a new memory (i.e., performing the previously described data capture and storage workflow method for updating the personal knowledge base).

Thus, the AI-driven personal assistant system responds to both user-driven queries and context-driven triggers by performing the contextual memory recall process to provide just-in-time information from the user's own historical data (i.e., from the user's personal knowledge base). The contextual memory recall process emphasizes retrieving the right information at the right time by leveraging the system's long-term memory and context awareness. This contextual memory recall capability is a core innovation of system that differentiates it from traditional personal assistants, which typically require explicit questions and do not automatically surface past relevant information during live situations.

### The Proactive Suggestion and Task Automation Process for Proactive Action

The AI-driven personal assistant system is also capable of acting on its own initiative to help the user, based on learned patterns or predefined rules, rather than waiting for user queries. Such proactive, independent action by the system may improve or optimize the user's routine, with appropriate user preferences and control and is prompted and structured by a proactive suggestion and task automation process performed by the system. An exemplary embodiment of such a proactive process loop includes, but is not limited to, the following steps: continuously monitoring context; evaluating one or more trigger conditions or rules; checking the relevant trigger conditions/rules against current context; formulating at least one suggestion (suggested action); checking for user approval; notifying user and confirming user approval if required; and executing action. In some embodiments of the AI-driven personal assistant system, the proactive suggestion and task automation process may further include the additional steps of: logging the outcome and gathering feedback on the executed action; and learning from the outcome of the executed action. Additional details and explanation will now be provided for each step of the proactive suggestion and task automation process.

Continuous Context Monitoring: The system continuously (or at regular intervals) monitors the user's current context and state in the background. This includes gathering data such as the time of day, the user's schedule (calendar events), device activity (e.g., detecting that the user is on a phone call, or that the user's car Bluetooth is active indicating they are driving), unread notifications or messages, the user's location, and even biometric or environmental data (for example, stress level from a wearable, ambient noise level, etc.). The monitoring can be event-driven (triggered by context changes like “a new message arrived” or “user arrived at home”) and/or done in a periodic loop that checks conditions on a schedule.

Trigger Condition Evaluation: The system evaluates the current context against a set of known trigger conditions or rules that would warrant a suggestion or automated action. These conditions can be predetermined (programmed rules) and/or learned (patterns the AI has recognized over time from the user's behavior). Examples of trigger conditions and rules include, but are not limited to:

Situation-based rule: “If the user is driving and there are unread text messages, then suggest reading the messages aloud.”

Time-based rule: “If it is 30 minutes before a scheduled meeting and a calendar conflict exists, then offer to resolve the conflict (e.g., propose rescheduling one of the meetings).”

Behavior pattern: “If it is around the user's usual lunch time and they have no meeting, then suggest ordering lunch.”

Physiological cue: “If the user's heart rate is high (indicative of stress) during a meeting, then suggest a short break or a breathing exercise.”

The above examples of trigger conditions and rules illustrate possible scenarios in which the system can provide assistance to the use without being explicitly asked. The trigger conditions and rules may be configured by the developer or the user, and they may also be derived from the system's machine learning (e.g., the system may recognize a repetitive behavior and form a new trigger rule to proactively suggest or perform the behavior/action).

Condition Check: The system continuously or periodically checks the relevant trigger conditions against the current context. There may be multiple potential triggers true at once; the system can prioritize them or handle them one at a time. If no trigger condition is met, the system simply continues monitoring passively (no action is taken). If one or more conditions are satisfied (meaning a situation has arisen that warrants assistance), the system selects the highest-priority trigger to address (or potentially prepares multiple suggestions if they are not conflicting).

Suggestion Formulation: Once a specific trigger is activated, the system formulates a concrete suggestion or action plan to assist the user. This involves determining what action should be taken and the details of that action. For example:

If the “driving with unread messages” trigger activates, the suggested action might be “read aloud the new text messages.” The system will gather the content of the unread messages as the payload for this action.

If the “calendar conflict” trigger activates, the action could be “reschedule one of the meetings.” The system would determine which meeting can be moved and propose a new time (payload might include the meeting details and the proposed new time).

If the “offer to order lunch” trigger activates, the system might decide on the user's usual order or prepare a few options (payload: a suggested menu item or a prompt to pick an order).

If a pattern like “user consistently forgets task X” is identified, the system might prepare the content for that task (e.g., draft an email update for the user to review).

In each case, the system also generates a user-facing prompt or message that clearly describes the suggestion in a user-friendly manner (for example, “You have two meetings overlapping. Shall I move the team sync to 11:00?” or “It's 12:00 PM, would you like me to order your usual lunch?”). The formulation step ensures the proposed action is appropriate and that the prompt is understandable to the user.

User Approval Check: Before executing the proposed action, EEPIS checks whether this type of action requires user approval or confirmation under the current settings. The user's governance preferences (managed by module 106) specify which actions are allowed autonomously and which must be approved. For instance, a user might allow automatic reading of texts aloud while driving (for safety) but require confirmation before sending any messages or spending money on an order. The system evaluates whether explicit approval is needed: if the user has previously marked this action type as “always allow,” or if the user has given blanket permission for the current context, then no approval is required and the process can skip directly to execution. If approval is required (which is the default for most non-trivial actions unless configured otherwise), the workflow will proceed to the next step. In general, especially for new types of suggestions, the system errs on the side of caution and assumes approval is needed unless configured otherwise.

User Notification & Confirmation: If approval is required, the system presents the suggestion to the user and requests confirmation to proceed. This notification is delivered via an appropriate interface: for example, if the user is using AR glasses, a small pop-up could appear in their view with the proposed action and “Yes/No” options; if on a phone, a push notification could be sent with Accept/Decline buttons; if using a voice interface, the system could verbally explain the suggestion and listen for a spoken yes/no. The prompt includes enough detail for the user to make an informed choice (e.g., which meeting will be rescheduled to what time). The user then provides input—which could be a voice response, a tap on a button, or even a thought gesture via BCI if available (for instance, a certain brainwave pattern could signify “yes”). The system captures the user's response. If the user approves the suggestion, the flow proceeds to action execution. If the user declines, the system cancels the action (and may note the refusal as feedback). If the user ignores the notification (no response within a certain time window), the system treats it as a declination and does not execute the action. Throughout this step, control remains with the user; no significant action is taken unless the user consents.

Action Execution: If approval was obtained (or if it was not needed per the user's settings), the system executes the suggested action automatically. Execution involves interfacing with the relevant external systems or internal functions to carry out the task. Examples include, without limitation:

For reading messages: the system utilizes text-to-speech to read the content of the messages over an audio output (e.g., the car's speakers or the user's headset).

For rescheduling a meeting: the system communicates with the calendar application (via an API) to move the event to the new time and sends out updated invitations to participants.

For ordering lunch: the system places the order through a food delivery service's API, using stored preferences for the item and payment method (unless it needed to ask the user for specifics).

For drafting an email or report: the system composes the text (possibly using a language generation model) and either sends it automatically if permitted, or saves it as a draft for the user to review.

Essentially, the AI-driven personal assistant system identifies and performs steps that the user would otherwise have had to do manually. If the action is complex, there might be sub-steps or interactions with multiple services (for example, rescheduling a meeting might involve checking multiple calendars, contacting attendees, etc., which the system handles in the background). The goal is that from the user's perspective, the action/task is taken care of. Assuming everything goes well, the intended outcome is achieved without the user's manual or even conscious intervention.

In some embodiments of the AI-driven personal assistant system, the process of proactive suggestion and task automation further comprises logging the outcome and gathering feedback on the executed action, and learning from the outcome of the executed action. As will become evident, these optional additional steps can provide additional useful functionality to the system and are described in further detail below.

Logging and Feedback: After executing the action, the system may log/record the outcome and gather feedback on the result of the action. The system records in memory (i.e., the personal knowledge base) what action was performed for transparency and future reference. For example, it might create a log entry like “At 9:30 AM, the system rescheduled Meeting X to 11:00 with user approval,” or “Lunch order placed at 12:01 PM for Pizza.” This log becomes part of the day's event stream, so the user can later query something like “What did you do on my behalf today?” if needed. The system then checks if the action succeeded by looking at any responses from external application programming interfaces (APIs) or the environment (e.g., the calendar API returned a success status, or the food order got a confirmation number). If the action failed (perhaps due to network issues or an unavailable service), the system handles that by notifying the user (e.g., “I couldn't complete the order”) or trying a fallback strategy. Assuming success, the system might also observe the user's reaction (if any) to gauge satisfaction. This step ensures the system remains accountable, and it allows the user to review any autonomous actions taken.

Learning from the Outcome: The system uses the results of the action and the user's feedback (implicit or explicit) to update its models and rules for future decisions. If the suggestion (suggested action) was accepted and the action was successful, the system gains confidence that this was a helpful intervention and may reinforce the analysis pattern that led to the suggestion. Over time, if a particular suggestion is consistently accepted, the system might even offer to automate it completely (for example, “I noticed you always approve this suggestion; shall I perform it automatically next time?”). Conversely, if the user frequently rejects a certain type of suggestion, the system learns to offer it less often or to adjust the conditions under which it triggers. Additionally, any new data from the execution (e.g., events created by the action, changes in the user's schedule) are fed back into the memory and context for future use. This learning step closes a feedback loop, allowing the AI-driven personal assistant system to become more personalized and efficient with experience over time. The next time a similar context arises, the system will be better calibrated for deciding whether and how to intervene, with a greater likelihood of success.

When the AI-driven personal assistant system implements the proactive suggestion and task automation process, especially including the aforesaid optional feedback and learning steps, the system advantageously performs as an autonomous agent on the user's behalf, rather than simply a passive tool as is the typical role of existing personal AI assistants. The presently described and contemplated system balances automation with oversight: the user's preferences govern when the AI can act freely and when it must ask permission, ensuring the user retains ultimate authority. By continuously monitoring context and carefully choosing moments to help, the system can save time and reduce cognitive load for the user (for example, by taking care of trivial chores or reminding the user about things they might have forgotten). This proactive functionality of the system fills a gap in current assistants, which do not take such initiative. The presently described and contemplated AI-driven personal assistant system effectively provides the user with a virtual assistant that is always paying attention to the user's context and striving to improve the user's productivity and well-being, all while respecting the boundaries set by the user.

In some exemplary embodiments, the AI-driven personal assistant system may further comprise an AI-driven challenge module which encourages and guides personal growth by applying one or more AI-driven engagement methodologies selected from challenging, questioning, and providing constructive feedback to the user. These methodologies promote user self-awareness, mitigate cognitive biases, enhance decision-making quality, and support ongoing personal growth and cognitive enhancement. More particularly, the AI-driven engagement methodologies that extend beyond passive user interaction by actively challenging user assumptions, prompting reflective thinking, and providing counterpoints to user inputs.

The engagement methodologies offering one or more types of constructive communications and include, but are not limited to: a bias detection and cognitive challenge; an interactive verification and intent clarification; context aware pushback; constructive emotional and behavioral feedback; and a dynamic user reflection interface. Each of these engagement methodologies is explained below in further detail.

### Bias Detection and Cognitive Challenge

The system automatically detects potential cognitive biases or logical inconsistencies within user statements, goals, or actions. Upon detection, the AI-driven challenge module proactively prompts the user with clarifying questions or alternative perspectives designed to encourage deeper reflection and reconsideration.

### Interactive Verification and Intent Clarification

When processing significant user decisions or stated intentions, the AI-driven challenge module initiates an interactive verification dialogue. This dialogue systematically ensures the user's intentions align with their previously stated long-term objectives or preferred values.

### Context-Aware Pushback

Leveraging historical user data, the AI-driven challenge module generates tailored and context-aware pushback to proposed actions or conclusions. For instance, if a user decision deviates significantly from historical patterns, established goals, or preferred outcomes, as understood by the AI-driven personal assistant system, the AI-driven challenge module proactively questions the user to verify or reconsider such deviations.

### Constructive Emotional and Behavioral Feedback

Utilizing emotional analytics and behavioral tracking, the AI-driven challenge module provides constructive feedback when a user's emotional state or behaviors significantly diverge from baseline patterns learned by the AI-driven personal assistant system, potentially impacting decision quality or long-term objectives.

### Dynamic User Reflection Interface

The AI-driven challenge module of the AI-driven personal assistant system includes a dedicated dynamic interface or module explicitly designed for critical reflection and cognitive bias mitigation, engaging users through periodic reviews, proactive challenges, and constructive questioning.

These AI-driven engagement methodologies of an AI-driven challenge module provide users of the AI-driven personal assistant system with personalized, thoughtful, and proactive interaction designed not only for memory retention and optimization but also for enhanced cognitive clarity, self-awareness, and growth.

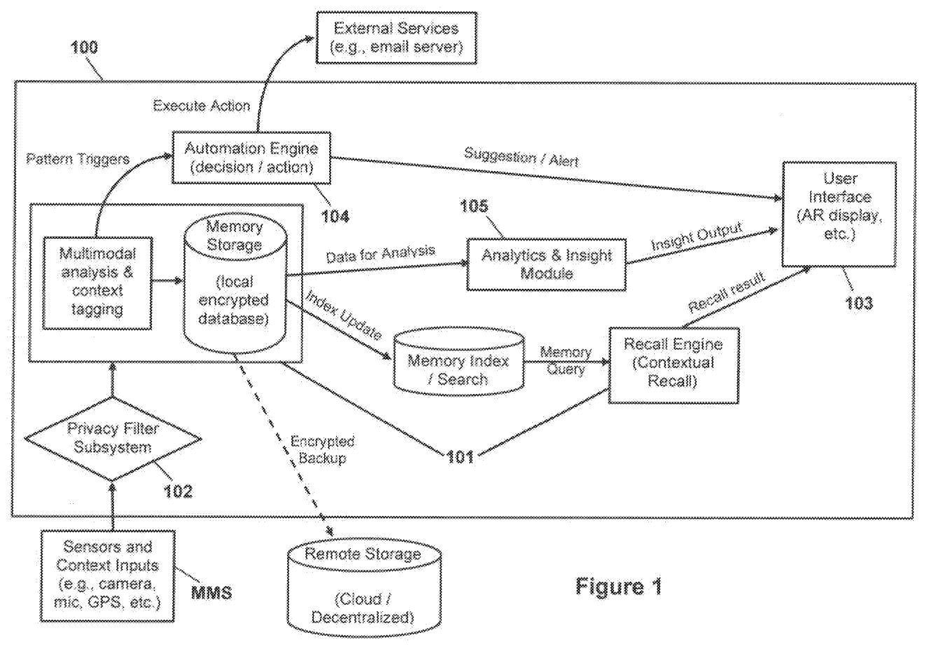

The above described several components of the AI-driven personal assistant system and its performance of the methods disclosed and explained above enable the system to provide many individual and combined functionalities and capabilities uniquely effective for and beneficial to users seeking to improve personal efficiency, productivity and well-being. With reference now to FIGS. 1-12, additional descriptions will now be provided for the components of the system, as well as how they function and operate together to enable the system to perform the methods described above.

FIG. 1 provides a block diagram of the general architecture and components of the AI-driven personal assistant system 100, as well as their operation and interactions with one another. Basic functional components of the system include the memory engine (101), the Privacy/Data Management Subsystem (102) (only the Privacy Filter portion is shown in FIG. 1), the Context Recognition & User Interface Subsystem (103), the Automation & Decision Engine (104), and the Analytics & Insight Module (105).

Multimodal sources (MMS) of input, such as sensor inputs (e.g. camera, microphone, biosensors, location) feed into the system 100, first encountering the Privacy Filter (part of the Privacy/Data Management subsystem (102)) that enforces user-defined privacy rules to provide allowed/permitted data to proceed and be processed by other components of the system. Allowed data flows (is provided) to the Multimodal Analysis & Context Tagging module (part of the memory engine (101)) for processing (speech-to-text, image recognition, etc.) and context annotation. Processed information is then stored in an episodic memory store (encrypted local database, with secure cloud backup) and indexed in the Memory Index/Search component for later retrieval. Simultaneously, recognized patterns can trigger the Automation Engine (104) for real-time suggestions or actions. The Analytics/Insight Module (105) performs cross-domain analysis on stored data to generate higher-level insights, feeding results back to the user. User interactions occur through the User Interface (103)—e.g. AR displays, notifications, or voice—which both presents recall information and handles user input (queries, commands), closing the feedback loop.

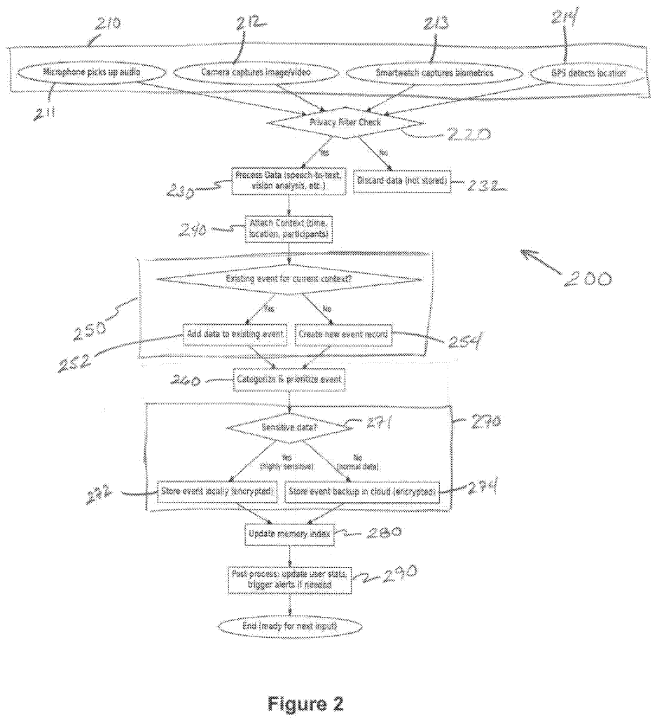

FIG. 2 provides a flowchart of the multimodal data capture and memory storage process (200) (i.e., the data capture and storage method described above). Multiple sensor inputs (210), including without limitation, audio (211), video (212), biometrics (213), location (214), etc., concurrently provide user data and information which is received and analyzed by the privacy filter check (220). At the Privacy Filter Check (220), a decision is made as follows. If the incoming data is allowed/permitted under user-selected privacy settings, processing continues with Data Processing & Analysis (230). However, if the incoming data is not allowed according to those user-selected privacy settings, the data is discarded (232) (not recorded).

The allowed data undergoes Data Processing & Analysis (230), in which the system converts raw data inputs into structured information (e.g. audio to text, image to recognized entities) as previously described above. Next, the method includes the step of attaching context (240) (time, location, participants, etc.) to the data, enriching it with situational metadata. An Event Formation decision (250) follows: the system checks if the data belongs to an existing event context (ongoing session)—if yes, it adds the data to that existing event (252); if no, it creates a new event record or entry (254). After updating or creating an event, the system categorizes and prioritizes the event (260) based on content and context (e.g. tag as “Work meeting” or determine importance).

Next, the Secure Storage Selection is performed 270 to decide where to store the event data (local device (272), cloud backup (274), and/or decentralized storage (not shown)) according to its sensitivity. More particularly, a decision “Sensitive data?” (271) splits the path whereupon highly sensitive data is kept only in secure local/decentralized storage (272), while other data is also backed up to the cloud (274) (all data is encrypted in either case). After storing, the system updates the Memory Index (280) to make the new event searchable.

A post-processing step (290) then performs analytics on the event—e.g., updating user statistics or triggering immediate follow-ups (such as reminders for tasks noted. At the end of the multimodal data capture and memory storage process (200), the data has been securely stored and indexed, and the system returns to monitoring Multiple sensor inputs (210) for the next data input. This multimodal data capture and memory storage process (200) is repeated continuously for each new data stream, ensuring all relevant user experiences are captured in memory (i.e., the personal knowledge base, not shown).

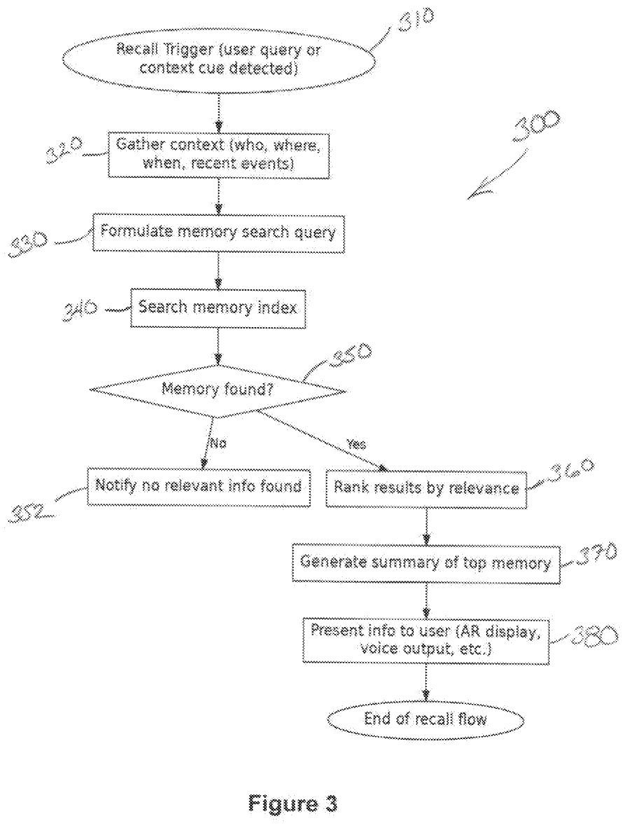

FIG. 3 provides a flowchart of the contextual memory recall process (300) previously described above, during which the AI-driven persona assistant system retrieves and presents stored information to the user based on a query or context cue. The contextual memory recall process (300) commences upon the occurrence of a Recall Trigger (310)—either an explicit user query (e.g. the user asks a question via voice or text) or an implicit context cue (e.g. the system recognizes a person's face via AR, or detects the user's location) that prompts a memory search.

Upon occurrence of such a trigger (310), the system gathers context (320). For example, relevant situational details are collected, e.g., who is present, where the user is, the current time, and recent events or interactions related to the cue. Using this rich context, the system formulates a memory search query (330)—essentially translating the situation into keywords or parameters for querying the memory index. Next, the Memory Index is searched (340) for matching events or information. A critical decision follows: “Memory found?” (350). If no relevant memory is found (352), the system will gracefully handle it (e.g. notify the user that no information was found for that query/context). If one or more matches are found, the system proceeds to rank the results by relevance (360), for example favoring more recent or significant events as described in the disclosure. The top result is then used by the system to generates a concise summary of that memory (370) (key details like when it occurred, the context, any important promises or data).

Finally, the system delivers the recall summary to the user (380) via the appropriate interface-for instance, overlaying text in the user's AR glasses view, speaking the summary aloud, or showing a notification on a device. This allows the user to instantly recall the needed information in context (e.g. seeing a brief summary about a person they just encountered). After completion of the contextual memory recall process (300), the user has been informed; if the user needs more detail, they could trigger another recall (not shown here, but mentioned as an optional “follow-up” and continuation hereinabove). Throughout this process, the system ensures that only the authenticated user perceives the recalled information (protecting privacy in shared environments), and it continuously links new experiences to past memories (for example, the current interaction itself would be recorded for future recall).

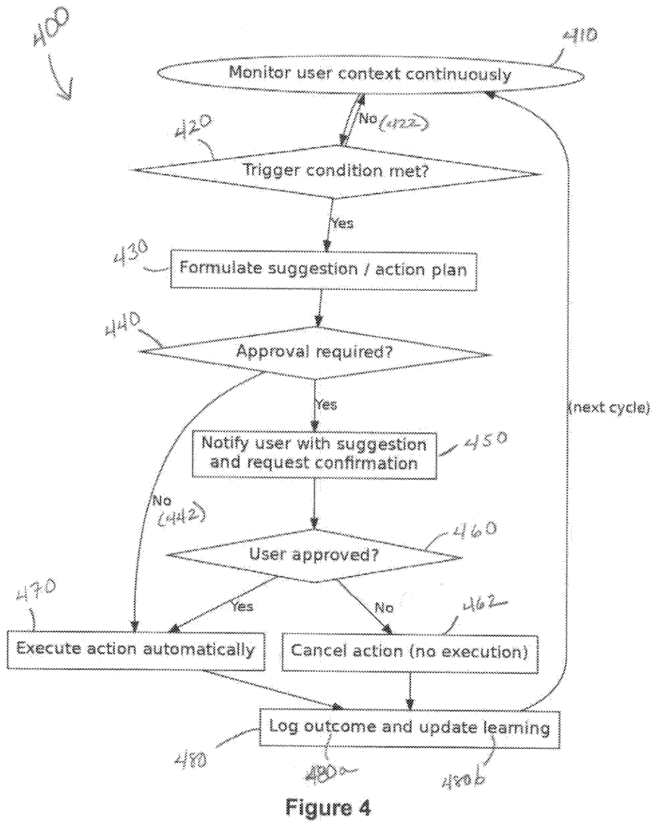

FIG. 4 provides a flowchart of the proactive suggestion and automation process (400), during which the AI-driven personal assistant system monitors the user's context and acts autonomously to assist, subject to user preferences. In accordance with this process (400), the system continuously monitors (410) the user's context (time, location, activity, sensor data, etc.) for any conditions that might warrant assistance. The first decision, “Trigger condition met?” (420), evaluates whether the current context matches any predefined rule or learned pattern for proactive action. If no conditions are met, the system simply continues monitoring (looping back with no action (422)). If yes, then a trigger event is recognized (e.g. the user is driving and an unread text is detected, or it's nearly a meeting time with a conflict on the calendar) and the system proceeds to formulate a suggestion or action plan (430). In this formulation step (430), the system decides what assistance to offer and prepares the details (for example, deciding to draft a meeting reschedule proposal and identifying a better time slot).

Next, the system checks and verifies whether user “Approval required?” (440). Based on user-defined policies and rules, and the nature of the action, the system determines (440) if it can execute the action autonomously or if it should ask the user first. If no approval is needed (442) (for benign or pre-approved tasks), the flow skips ahead to execute the action directly ( ).

If yes, user approval is required, then the system will notify the user with the suggestion and request user approval (450), such as by an AR prompt, a phone notification, etc., describing the suggested action and offering accept/decline options. Then a decision “User approved?” is made (460) and if the user declines or ignores it, the system cancels the action (462) (no changes are made). On the other hand, if the user approves the suggestion (or if it was auto-approved), the system executes the action on the user's behalf (470)—for example, sending a message, adjusting a device setting, or ordering a service—by interfacing with the relevant external APIs or devices.

After execution of the action (470), the system enters a post-action phase (480), during which the outcome of the action is logged/recorded and feedback is collected regarding the results of the executed action, noting success or failure and any relevant responses (480a). It then updates its learning models (480b) based on the result—reinforcing actions that were successful and approved, or adjusting its behavior if the suggestion was declined or the action failed. Finally, the system returns to the context monitoring step (410) (Step 9), with the system now a bit smarter about the user's preferences (for instance, it might not prompt again for the same suggestion if the user consistently declined it). This proactive workflow illustrates how the system “thinks ahead,” yet always keeps the user in control through decision and permission checkpoints (420, 440, 460).

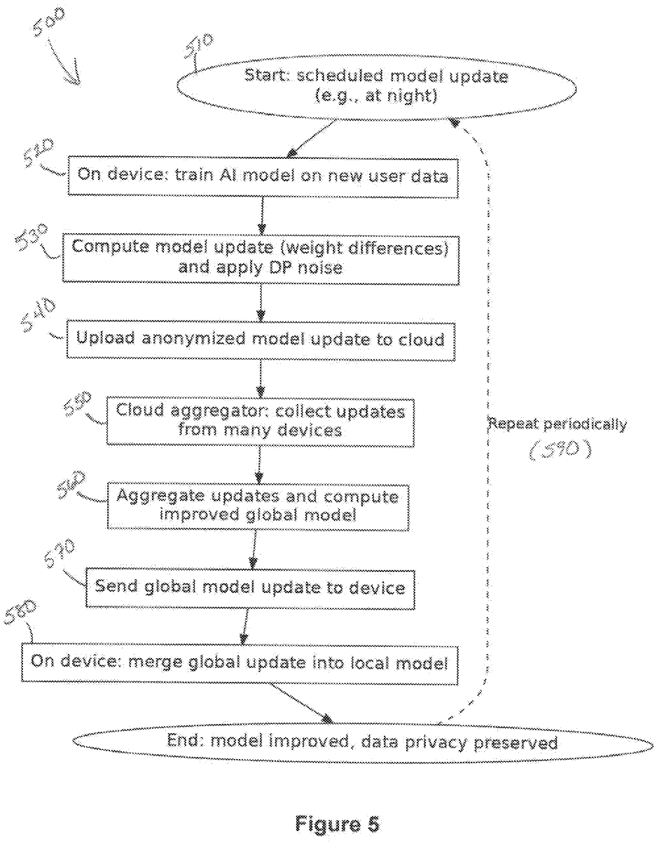

FIG. 5 provides a flowchart diagram of a federated learning and model update process (500) which may be performed according to some embodiments of the AI-driven personal assistant system. The federated learning and model update process (500) provides an additional subsystem which may be scheduled to run at convenient time intervals (510), such as at night, on a weekly basis etc., and ensures that the system improves over time even without centralized data collection. During this process (500), the user's device performs local model training on new personal data (520). By performing the local model training (520), the system refines itself using the latest user-specific data (messages, behavior patterns, etc.) stored in the personal memory.

Once local training (520) is completed, the device computes a model update (the difference between the updated model and the previous model) and applies differential privacy (DP) noise to that update to anonymize it (530), ensuring no private details can be reconstructed. The device then uploads this anonymized model update to the system's cloud aggregator (540). In the cloud aggregation step, the server collects model updates from many users' devices (550) (each update is small and contains no raw personal data). The server aggregates and combines these updates (560)—for example, by averaging the weight differences—to compute an improved global model that incorporates learnings from across the user community (560).

Next, the server distributes the global model update back to each device (570). The user's device receives this global update and merges it into its local model (580), thereby benefiting from collective learning (e.g. adapting to new slang or scenarios observed in others' data) without ever exposing individual data. This cycle (local train→upload update→aggregate→download update) repeats periodically (590), enabling the personal AI assistant system to get smarter both individually and as part of a federated network. Throughout the process, user data remains private —only abstract model parameters are shared—which aligns with the present AI-driven personal assistant system's privacy-first design (no raw timeline of events ever leaves the device).

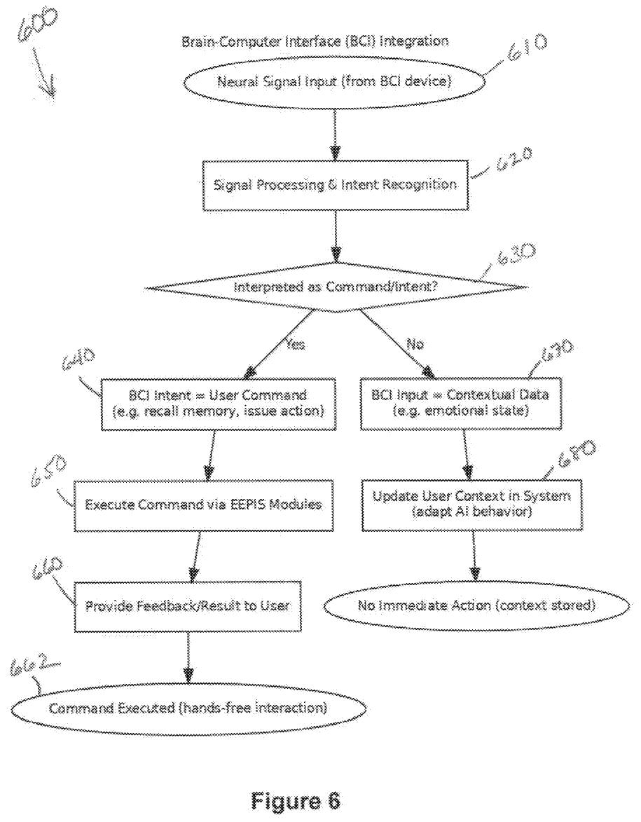

FIG. 6 provides a flowchart of a Brain-Computer Interface (BCI) Integration Process during which neural inputs would be provided to and flow through the AI-driven persona assistant system, thereby integrating a future brain-computer interface into the system's workflow. Raw neural signals captured from the user by a BCI device (e.g., an EEG headset) are provided to the system (610). The system processes the raw neural signals to detect any meaningful intent or command (620).

At a decision point, the system interprets whether the neural signal corresponds to a deliberate user command/intent, or is simply contextual data (such as an emotional state) (630). If a concrete command is recognized (640) (e.g. the user “thinks” a query or instruction), routes it to the appropriate module of the system—for instance, recalling a memory or executing an action—enabling truly hands-free interaction via thought (662). The system then carries out the command (650) and provides feedback to the user (660) (perhaps via an AR display or audio), completing the thought-triggered action.

If no explicit command is detected (i.e. the BCI input reflects context like stress or concentration level) (670), the neural data is used to update the user's context within the system (680). For example, a detected high focus level might prompt EEPIS to hold off non-urgent notifications, leveraging the user's cognitive state to adjust its behavior. In either case, the BCI integration allows the system to respond to neural cues—proactively assisting based on intent or adapting to the user's mood, which is an optional novel, forward-looking feature of the system.

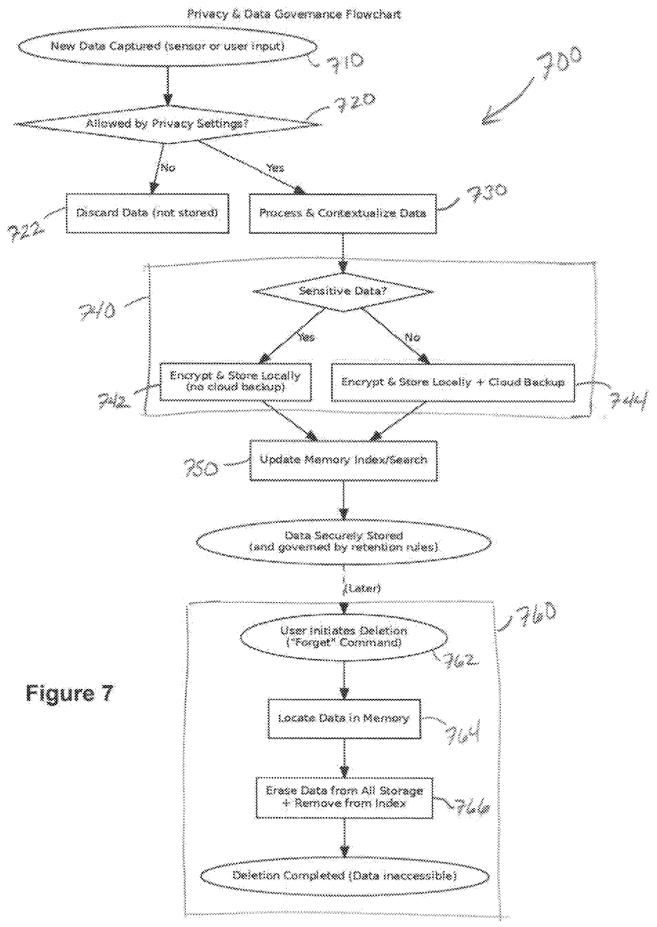

FIG. 7 is a flowchart showing the privacy and data governance processes performed by the privacy/data management subsystem described earlier which enables the system to receive, analyze and, store and otherwise manage handle user data with a privacy-first design. The privacy and data governance process starts with new data captured from sensors or user input (710), immediately subjected to a privacy check (720). If the data is disallowed by the user's privacy preferences and rules, it is discarded and not stored (722).

Allowed data, on the other hand, continues through processing and contextual tagging (730), and then a sensitivity-based storage decision (740) is made. Highly sensitive information is kept only in secure local storage (742), whereas other data is encrypted and backed up to the cloud for redundancy (744). After storage, the system updates its memory index (750) to enable quick search and recall of this data.

The diagram of FIG. 7 also shows a user-initiated deletion sequence (the “Forget” command) (760) which may be activated and performed by the system as part of ensuring user privacy. More particularly, at any later time, the user can choose to delete stored information (762). Upon such a request, the system will locate all copies of the targeted data across local or cloud stores (764) and permanently erase them, updating indexes and logs accordingly (766). This ensures compliance with data governance policies (e.g. the “right to be forgotten”) and gives the user full control over what is retained or removed in their personal data vault.

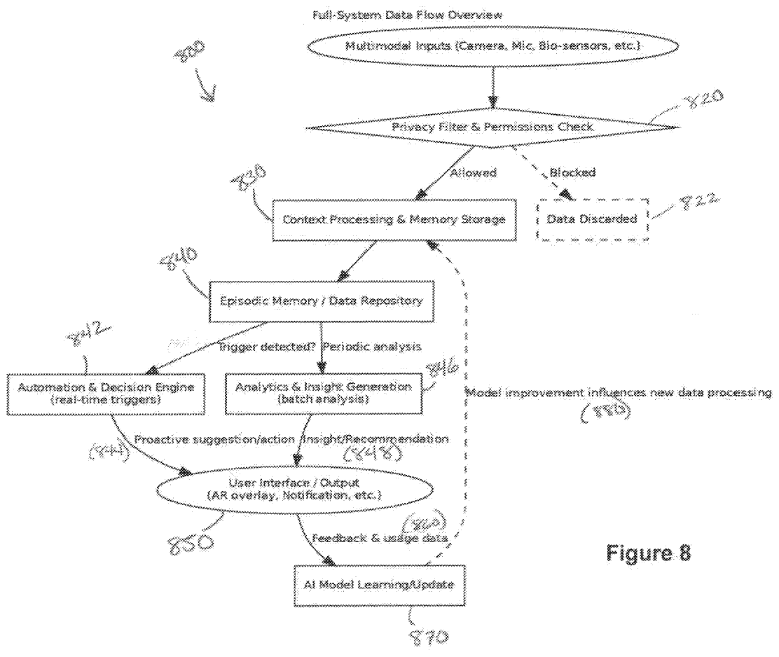

FIG. 8 provides a high-level process flow diagram summarizing the path (800) of user data and its receipt, management, storage, and use by the AI-driven personal assistant system, from input to output. The diagram of FIG. 8 provides highlights regarding how the system senses, decides, learns, and acts based on the user data and information it receives. First, multimodal sensor data inputs (camera, microphone, biosensors, etc.) are collected (810) and provided to the privacy filter (820). The privacy/permission checks conducted by the privacy filter ensures only authorized data passes through. Any data violating user-set rules is blocked and discarded (822).

Approved data is then contextualized (e.g. tagged with time, location, recognized entities) and stored (830) in the episodic memory repository (840). From the memory/data repository (840), two parallel pathways unfold: a real-time automation & decision engine monitors incoming information for triggers (842) to immediately assist the user, and an analytics module performs deeper batch analysis to derive insights or trends (846) from accumulated data. If a trigger condition is detected (842) (for example, a pattern that matches a user's preset rule), the automation engine may generate a proactive suggestion or action for the user (844).

Meanwhile, the analytics component (846) might produce a higher-level recommendation or alert (848) based on patterns over time (for instance, an insight about the user's habits). Both pathways lead to user-facing outputs (850)—either through an AR interface, a notification, or another UI—thereby closing the loop by delivering assistance or information back to the user. Finally, the system also includes a learning process/phase wherein the user's feedback and the outcome of actions (860) feed into an AI model update process (870). The personal AI model refines itself using these new data points (and potentially federated updates from other users, as described later), ensuring the system improves over time (880). This continuous learning means each cycle makes the system smarter and more attuned to the user, without compromising the user's privacy.

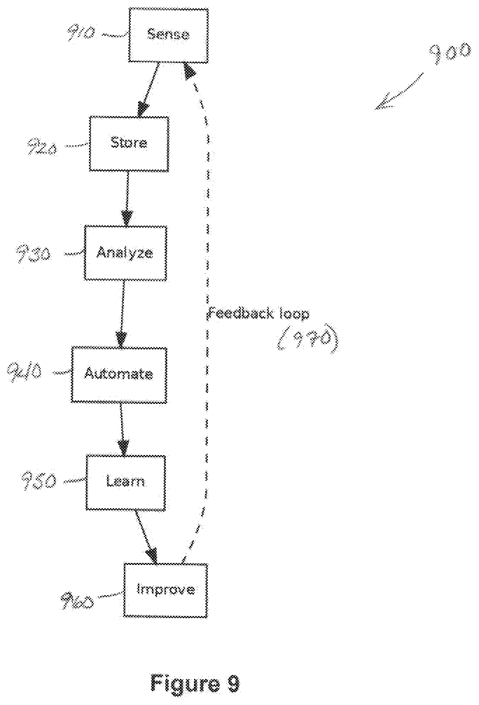

FIG. 9 is a schematic diagram showing, at a high level, six general stages of operation (900) performed by the AI-driven personal assistant system: Sense (910)→Store (920)→Analyze (930)→Automate (940)→Learn (950)→Improve (960). In the Sense phase (910), the system perceives inputs from the user's environment (sensors capturing audio, video, biometrics, etc.). Next, in the Store phase (920), important information from those inputs is securely stored into the user's personal memory database (after filtering and processing). The Analyze phase (930) involves processing the stored data to understand context and extract insights—for example, recognizing patterns, annotating context, or correlating information.

Following analysis (930), the system performs the Automate phase (940), where it uses the insights and triggers to autonomously assist the user (such as suggesting an action or performing a routine task) subject to user preferences. The outcomes of those actions and interactions then feed into the Learn phase (950) wherein the system updates its AI models based on what happened—reinforcing successful behaviors and adjusting when the outcomes are not as desired. Finally, the knowledge gained is used during the Improve phase (960) to modify and improve the system's overall performance. This improvement directly feeds back into the next sensing phase (dashed feedback loop (970)), closing the cycle. Through repeated iterations (970) of this loop of phases (910, 920, 930, 940, 0950, 960), the system continually self-optimizes and evolves—effectively becoming more intelligent and personalized with each iteration. Visualization of the six-phase loop (900) provided by FIG. 9 clarifies and emphasizes the system's design and operation as an ever-learning personal assistant system that senses context, remembers and learns from it, and proactively adapts to better serve the user over time.

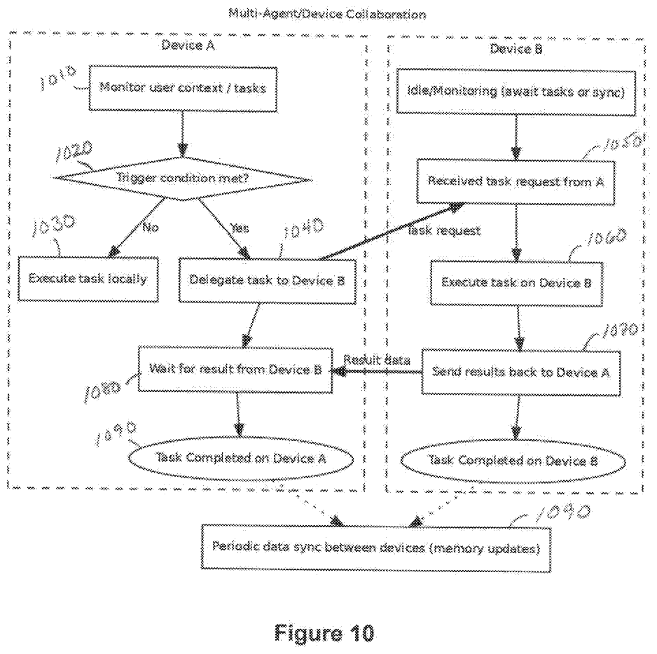

FIG. 10 is a flowchart showing how multiple system instances (e.g. on a user's phone and laptop) collaborate to share tasks and data. As indicated on the left side of FIG. 10, Device A (e.g., phone) continuously monitors context (1010) for any condition that triggers an automated task (1020). If a task can be handled locally, Device A executes it immediately (1030). If not, the system checks whether it should delegate the task to another device (1040) (perhaps for reasons of efficiency or availability). When delegation is needed (1040, branch “Yes”), Device A sends a task request to Device B (see right side of FIG. 10). Device B receives the request (1050), performs the task (1060) on behalf of Device A, and returns the result back to Device A (1070). Device A waits for this result (1080), then integrates the outcome and completes the task (1090). Both devices also periodically sync data (1090, dotted line at bottom) to ensure their local memories and context are up-to-date. This multi-agent design enables the system to provide a coordinated personal AI experience across a user's ecosystem of devices—for example, two devices can negotiate which one should handle a task for optimal efficiency, a capability not seen in single-device assistants. The result is a seamless collaboration where the AI-driven personal assistant system performs work on multiple user devices in unison, sharing updates and responsibilities while respecting the user's privacy and intentions.

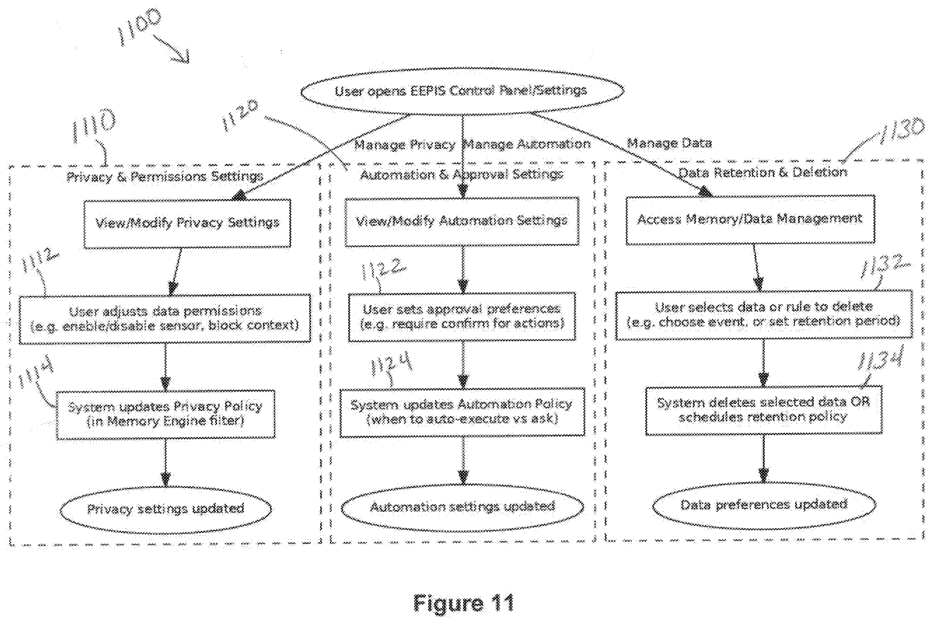

FIG. 11 is a diagram which shows the arrangement of setting options provided on the system's control panel interface (1100) for enabling the user to control the AI-driven personal assistant system's behavior in three key areas: privacy and permissions (1110), automation and approvals (1120), and data retention and deletion (1130). Thus, user oversight is built into the system at every level. The intuitive control panel (1100) enables users to actively govern their data (what is stored or erased) and the system's autonomy (when it must pause for approval), which together ensure the system operates transparently and in line with individual privacy and security preferences. Once the user accesses the system's control panel having a settings interface, the user can manage privacy and permissions settings (1110), automation and approval settings (1120), or data management (1130) as follows.

Privacy & Permissions (1110)—The user can review and modify what data the system is allowed to capture and retain. For example, they might enable/disable certain sensors or block recording in specific contexts (1112). When the user updates these privacy settings, the system immediately applies the new rules to the privacy filter and data handling policies applied by the memory engine (1114). This gives granular user control over what is remembered or shared. Going forward, any incoming data that violates the updated permissions will be filtered out, ensuring the user's preferences are strictly enforced.

Automation & Approval (1120)—The user defines how autonomous the AI-driven personal assistant system can be. In the settings, the user can specify which types of proactive actions require confirmation (1122) and which can execute automatically (1124). For instance, the user may allow calendar scheduling fixes to be executed without asking, but require confirmation before sending a message on their behalf. The system updates its automation decision policies accordingly, so that during operation (as seen in the proactive automation flow), it will check these user-defined rules. The system always keeps the user in control by adhering to these preferences-only proceeding autonomously when permitted, otherwise seeking the user's approval before acting.

Data Retention & Deletion (1130)—The user can manage their stored memories and set retention policies. Through the interface, they might select specific recorded events or rules to delete (1132) or instruct the system to auto-delete certain data after a period of time (1134). The system will then carry out the requested deletions (erasing the data from all storage locations and indexes) or schedule the retention rules as directed. Every deletion is comprehensive, ensuring that no remnants remain-addressing the “right to be forgotten” by letting the user purge data completely at will. The fact that users can edit or delete any personal data at any time is a distinguishing feature of the system's privacy-first approach.

FIGS. 1-11 and the detailed descriptions of the AI-driven personal assistant system, its components and methods of operation provide illustrative examples of how the presently described and contemplated AI-driven personal assistant system may operate in various scenarios and for various purposes. Of course, the system is not limited to the exact components, architecture, and methods described above. Rather the scope and intent of the system allows for many variations and extensions.

For instance, the system could incorporate federated learning techniques to update its AI models using the user's data in a privacy-preserving manner—sending only anonymized model weight updates (no raw data) to a central aggregator if collective learning across users is utilized. Furthermore, the memory engine may employ advanced data structures like knowledge graphs or vector embeddings to represent the user's information, enabling even more efficient semantic search and recall. The privacy framework could leverage blockchain-based smart contracts to verify data deletions or enforce access policies for stored memories. The AR interface described could be supplemented or replaced with other interfaces (e.g., audio cues or haptic feedback) to accommodate different user preferences or accessibility needs. In all such cases, the core idea remains an integrated AI assistant that evolves with the user: learning continuously, remembering indefinitely, and adapting its assistance to the user's life while empowering the user with full control over data and actions.

Although the invention has been described in connection with specific embodiments, those skilled in the art will appreciate that various modifications and alternative implementations of the above embodiments are possible without departing from the scope of the invention described and contemplated herein.

We claim:

1. A method for artificial intelligence (AI)-driven augmentation of user cognition, involving interaction with a user and comprising the steps of:
processing user-related data with associated context information and providing a personal knowledge database containing memories comprising the user-related data and associated context information, wherein the memories are searchable and retrievable as long-term memories;
performing data encryption, local, decentralized, or local and decentralized, storage of information and data, and enforcement of user privacy settings;
evaluating context information, making decisions, carrying out user-task automation, and providing suggestions to the user; and
performing cross-domain data analysis, and generating personalized insights, recommendations, or both.

2. The method of claim 1, wherein processing user-related data with associated context information and providing a personal knowledge database, each comprise one or more actions selected from capturing, analyzing, and storing, the user-related data with the associated context information.

3. The method of claim 1, sensing and capturing context information with associated user-related data, using one or more devices, and presenting the context information with its associated user-related data to the user through one or more interfaces.

4. The method of claim 3, wherein sensing and capturing context information is performed using one or more devices including cameras, microphones, and location sensors, and wherein the one or more interfaces are selected from: augmented reality displays, visual output, audio output, and other notification media.

5. The method of claim 1, further comprising receiving input which includes neural signals from the user's brain through one or more brain-computer interface (BCI) devices and neural sensors capable of sensing and transmitting neural signals, and using the input which includes neural when performing at least a portion of one or more other steps of the method.

6. The method of claim 1, further comprising the steps of:
performing continuous audio recognition, detection, and capture;
recording and storing captured audio in local memory, remote offline memory, or both, which is capable of receipt and at least temporarily storing the captured audio;
automatically transmitting audio from an audio receipt and capture device to either local offline memory capacity, remote offline memory capacity, or both; and
transmitting, uploading, or both transmitting and uploading stored audio from either of the local or remote offline memory capacities to one or more remote or decentralized storage networks, upon receipt of instructions and authorization from the user.

7. The method of claim 6, wherein performing continuous audio recognition, detection, and capture is performed at least in part using an audio receipt and capture device.

8. A personal assistant system for performing and providing artificial intelligence (AI)-driven augmentation of user cognition, and which is accessed and operated by a user, the system comprising:
a memory engine which is configured and programmed for processing user-related data with associated context information which provides a personal knowledge base (database) containing memories with context which is searchable and retrievable as long-term memories;
a privacy/data management subsystem which is configured and programmed for performing data encryption, local and decentralized information and data storage, and enforcement of user privacy settings;
a context recognition and user interface subsystem which is configured and programmed for sensing and capturing context information using one or more devices, and also for presenting the context information with its user-related data to the user;
an automation and decision engine which is configured and programmed for evaluating context, making decisions, and for carrying out user-task automation and providing suggestions;
an analytics and insight module which is configured and programmed for performing cross-domain data analysis and generation of personalized insights, recommendations, or both; and
a governance and control module which is configured and programmed for enforcing user-defined rules, managing permissions, and ensuring transparent and ethical AI operations.

9. The system of claim 8, wherein processing by the memory engine comprises one or more actions selected from capturing, analyzing, and storing, the user-related data with the associated context information.

10. The system of claim 8, wherein sensing and capturing context information by the context recognition and user interface subsystem is performed using one or more devices including cameras, microphones, and location sensors, etc.

11. The system of claim 8, wherein presenting the context information with its user-related data to the user by the context recognition and user interface subsystem is performed through one or more interfaces selected from: augmented reality displays, visual output, audio output, and other notification media.

12. The system of claim 8, wherein providing suggestions by the automation and decision engine includes providing suggested actions to the user.

13. The system of claim 8, further comprising a neural interface module which is configured and programmed for receiving input from brain-computer interface (BCI) devices and other neural sensors which transmit or otherwise provide neural signals to one or more modules of the system which uses the neural signals to analyze, determine and influence for the system's operation and behavior.

14. The system of claim 8, further comprising a bridging device which includes a multifunctional standalone component comprising:
an audio receipt and capture device capable of continuous audio recognition, detection, and capture;
memory capable of offline recording and storage of captured audio, including local and offline memory capacity for receipt and storage of captured audio, remote memory capacity capable of receiving and at least temporarily storing captured audio, or both local and remote memory capacity; and
one or more transmitters, each of which uses RFID, Bluetooth, IR, and other effective transmission formats and technologies which are same or different from those of others of the one or more transmitters, wherein a first one of the one or more transmitters is capable of automatically transmitting audio from the audio receipt and capture device to either local offline memory capacity, remote offline memory capacity, or both, wherein the first one of the one or more transmitters, or at least a second one of the one or more transmitters, is further capable, upon receipt of instructions and authorization from the user, of further transmitting, uploading, or both transmitting and uploading stored audio from either of the local or remote offline memory capacities to one or more remote or decentralized storage networks.

15. The system of claim 14, wherein the audio receipt and capture device comprises a microphone.

16. The system of claim 14, wherein the one or more remote or decentralized storage networks are selected from: a cloud server, and a blockchain-based storage node.

17. The system of claim 14, wherein the bridging device further comprises software instructions, applications, specialized programmed hardware computing devices, or a combination thereof, installed thereon and capable of operating one or more personal user devices and utilizing secure cloud and edge resources, which provides enhanced and expanded functionality of the of the bridging device and its subparts.

18. The system of claim 17, wherein the memory engine runs at least partially on a user device and captures sensor data, and utilizes cloud-based storage, distributed storage nodes, or both for backing up encrypted data.

19. A method for artificial intelligence (AI)-driven augmentation of user cognition, the method comprising: functionalities which include: persistent memory, contextual awareness, proactive automation, cross-domain intelligence, and privacy governance; remembering information indefinitely, providing contextually relevant assistance at contextually relevant moments, acting autonomously on a user's behalf under intelligent supervision, and concurrently maintaining user control of data and decisions.

20. The method of claim 19, wherein remembering information comprises at least capturing, storing, and recalling information.
